(19) United States
(12) Patent Application Publication
(10) Pub. No.: US 2004/0260767 A1
(43) Pub. Date: Dec. 23, 2004

(54) Dynamic web advertisement and content display system

(76) Inventors: David Kedem, Hezeliya (IL); Dana Ghavami, Franklin Lakes, NJ (US)

Correspondence Address: KATTEN MUCHIN ZAVIS ROSENMAN, 575 MADISON AVENUE, NEW YORK, NY, 10022-2585, US

(21) Appl. No.: 10/465,711

(22) Filed: Jun. 19, 2003

(51) Int. Cl. G06F 17/60; G06F 15/16

(52) U.S. Cl. 709/203; 705/14

(57) ABSTRACT

The present invention suggests a new ad campaign management system, which enables a campaign manager to determine ad type, scenario and performance parameters. These preferences are translated into campaign instruction sets that influence the presentation of the web-pages advertisement. The activation of the advertisements is performed by a java script program that is activated once the user starts to download the relevant web-page.

This system enable real time control of web-page advertisement presentation according to pre-determined instruction rules, technical browsing parameters, real time events, web-page structure and content. The ad controllable characteristics include size parameters, location parameters, animation behavior parameters, appearance period and timing conditional logic, style format parameters. The technical browsing parameters include: browser type and version, operating system type, communication bandwidth speed, width and height of browsing window, IP address etc. The triggering event include scheduled events, browsing events, and browsing interaction with user.

### FIELD OF THE INVENTION

The present invention relates to the management of advertising on the Internet and specifically to a system and method for enabling dynamic campaign advertisement in accordance with real time analysis of browsing activities and technical requirements.

### DESCRIPTION OF THE PRIOR ART

(The simplicity of browsing the web coupled with the relative low-cost of accessing the Internet, in that regard, by establishing web sites merchants, vendors and other information providers have an unparalleled opportunity to reach enormous numbers of potential consumers through advertising.)

Given the wide and ever-growing reach of the web as a source of consumer information and the increasing consumer acceptance of electronic commerce, advertisers have clearly recognized the immense potential of the web as an effective medium for disseminating advertisements to a consuming public.

Types of advertisements vary from an advertisement moving across the screen to a traditional fixed advertisement, which may appear in the unused portion of the web page.

Despite their widespread use as tools to drive electronic commerce on the Internet banner ads and other similar advertising and marketing mechanisms has generally yielded unsatisfactory results and thus has usually been avoided by most large advertisers. For example, in addition to the fact that banner ads are statically displayed once loaded by a web browser, banner ads and other similar marketing tools do not allow different and dynamic marketing content to be displayed within a browser window.

In that regard, several approaches exist in the art for implementing web based advertisements. However, all suffer serious limitations of one form or another that have sharply restricted their desirability and use.

Unlike traditional advertising environments such as T.V or newspapers, the Internet is an interactive and dynamic media, hence the advertisement campaigns have to be adapted to this new environment.

Prior art tools for planning and creating internet campaigns are unable to provide real time dynamic advertisement campaign, such deficiency may cause the campaign to be useless. For example, if ads are positioned in within a “scrolling” web-page some of the ads may never be exposed to the user view, as most users actually view only small portion of the page.

Prior art techniques which have approached the above problems provide solutions only for specific cases, such as adapting static ad resolution.

U.S. Pat. No. 6,314,451 discloses an advertisement management system, which selects the given advertisement that is to be downloaded, rather than having that selection or its content embedded in the web content page.

Many patents in the prior art involve customization of content. Some relate to customization of the advert resolution to suit the users resolution and others relate to customization of content to suit the profiling of the users.

U.S. Pat. No. 6,185,589 discloses an automatic banner resizing for variable-width web pages using variable width cells of HTML table.

While all of the previously discussed systems attempt to customize advertisements, none of them analyze the web page structure, real time browsing activities, device type and viewers' interaction, or create dynamic advertisements or content which is modified to match the user's viewing format preferences.

### SUMMERY OF THE INVENTION

The present invention provides a web-page advertisements playing system enabling real time control of web-page advertisement presentation according to pre-determined instruction rules, technical browsing parameters, real time events, web-page structure and content. The system is comprised of: Instructions rules database wherein the rules can be added or changed by all ad designer; First java script program which analyzes technical browsing limitations and related web-page structure for creating ad playing instruction sets based on predefined rules and said analysis result; Second java script for playing at least one ad wherein the ads appearance timing and characteristics are changed according to created instructions sets and the occurrence of identified triggering events

The instruction rules and instructions sets relate to combination of multiple ads characteristics and triggering events, wherein the activation of each ad is influence by combinations of different characteristics and events.

The instruction rules and instructions sets relate to combination of multiple advertising campaigns appearing in one or more web-pages, wherein the activation of one advertising campaign may influence other advertising campaigns.

The ad controllable characteristics include size parameters, location parameters (e.g. screen position, scrolling etc.). animation behavior parameters (e.g. motion, speed etc.) appearance period and timing conditional logic, style format parameters (e.g. color, fonts).

The technical browsing parameters include: browser type and version, operating system type, communication bandwidth speed, width and height or browsing window, IP address etc.

The triggering event include scheduled events, browsing events (e.g. downloading), and browsing interaction with user (e.g. mouse movement, scrolling etc.),

The instructions sets include logic parameters representing ad characteristics in relation to triggering events;

The instructions rules include logic commands of ad type and preferred characteristics of ads in relation to parameters of browsing technical limitation and web-page structure.

The system further includes a campaign wizard for enabling campaign designer to create instructions rules by selecting relevant ads type and scenarios, and select the preferred characteristics of the ad presentation;

### BRIEF DESCRIPTION OF THE DRAWINGS

These and further features and advantages of the invention will become more clearly understood in the light of the ensuing description of a preferred embodiment thereof given by way of example only, with reference to the accompanying drawings, wherein

FIG. 1 is a general diagrammatic representation of the environment in which the present invention is practiced;

FIG. 2 is a block diagram of the campaign management system according to the present invention;

FIG. 3 is a diagram illustrating the process of controlling real time campaign presentation according to the present invention;

FIG. 4 is flow-chart illustrating the real time process of composing ads according to the present invention;

FIG. 5 is flow-chart illustrating the real time process of analyzing a web-page according to the present invention;

FIG. 6 is flow-chart illustrating the real time activation of ad scenario according to the present invention;

FIG. 7 is flow-chart illustrating the process of campaign creation according to the present invention;

### DETAILED DESCRIPTION OF THE PREFERRED EMBODIMENTS

The main concept of the present invention is to enable real time control of web-page advertisement presentation.

Today campaign advertisements cannot be changed dynamically according to real time analysis of browsing events and specific characteristics of the displaying device. As described in the background, there are provided limited solutions for adjusting ad size according to the screen resolutions.

It is further required to allow the campaign manager to determine campaign preferences in regard to the dynamic browsing activities.

The present invention suggests a new campaign management system, which enables a campaign manager to determine ad type and performance parameters. These preferences are translated into campaign instruction sets that influence the presentation of the web-pages advertisement. The activation of the advertisements is performed by a java script program that is activated once the user starts to download the relevant web-page.

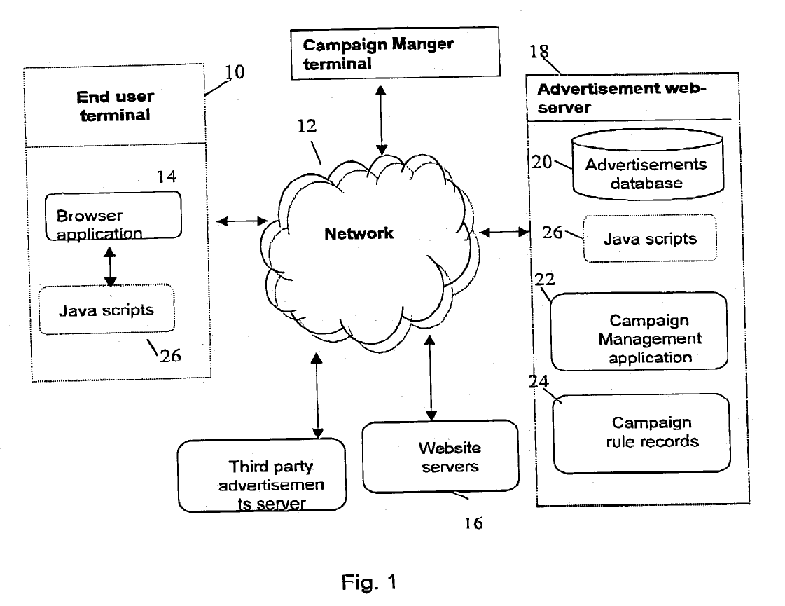

FIG. 1 illustrates the technical environment in which the present invention is practiced. Users terminal 10 are connected to the network 12 using a browsing application 14 and can access available web-sites, which are located at designated servers 16. The advertisement campaign management server 18 comprises of an ad database 20, a campaign management application 22, and a campaign rules records database 24. The campaign management application activates java script programs 26, which can be located at the management server or optionally at the client terminal.

The campaign management operation as suggested by the present invention is detailed in the following paragraphs.

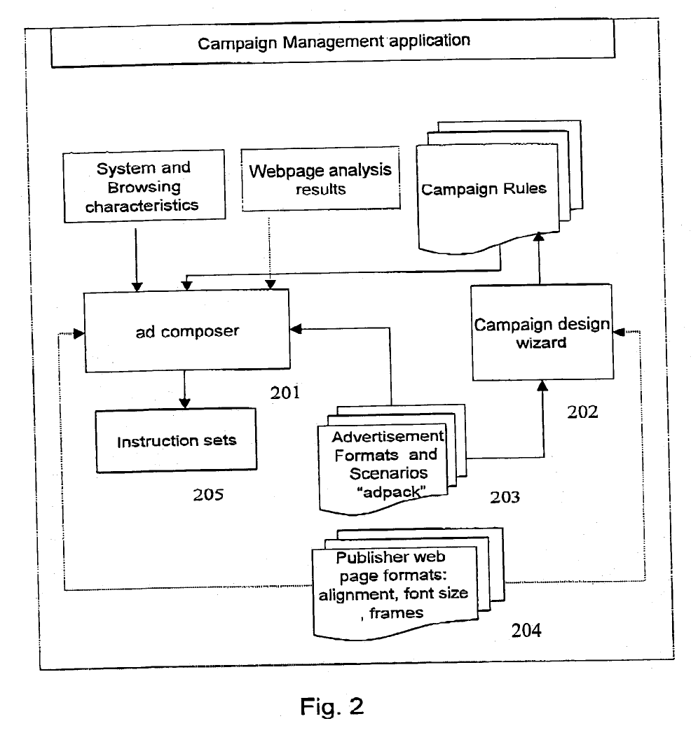

FIG. 2 illustrates the block diagram of the campaign management application. The application is mainly comprised of two components: the campaign design wizard 201 and the ad composer 202. The campaign design wizard enables the campaign manager to determine the campaign type and scenario and to select the relevant publishing web-site and presentation preferences according to pre-designed advertisement formats and scenarios 203 and optionally based on publisher web-page format (204) (such as frames, scrolling etc.). The wizard's application yields an output result of campaign rules. The ad composer which is implemented as a java-script program determines the specific ad campaign scenario preferences in real-time according to the predefined campaign rules, real-time analysis of the displaying device capabilities and web-page structure and content. This process of ad composing results a set of instructions 205, which determine the operative activation of the ads.

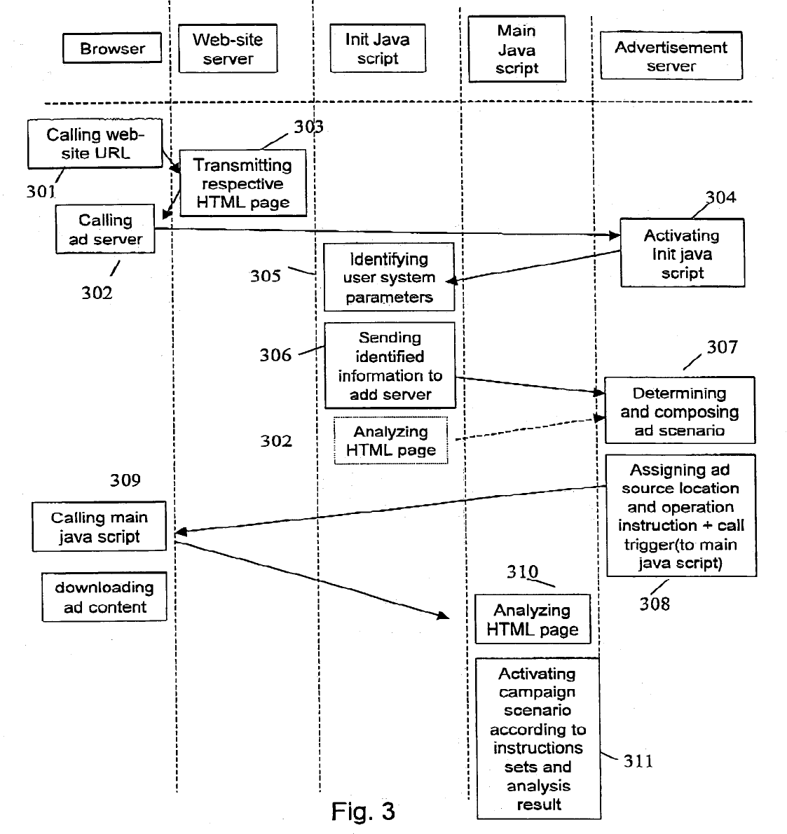

FIG. 3 illustrates the real time interactive process of advertising campaign operation. At the first step, the user initiates a request for downloading a web-page (301). In return the respective server site returns an HTML web-page, (302) which contains a command instruction to call the advertising servers (303) and activates an initial java script program (304). This initial script is programmed to identify the user system characteristics (305), including its browsing capabilities. Optionally, this program further analyzes the publishing web-page (306). All of this information is transferred to the advertising server. On the advertisement server's side, the ad composer determines the campaign type and scenario (307) and assigns the respective ad content source location (308). The ad composer's operation instruction sets and relevant information of ad content are transferred to the user's device browser including a calling instruction for activating the main java script. At the next step, the browser calls the main java script program (309), which is active during the browsing session of the specific web-page and controls the presentation of the campaign advertisement. The program first analyzes the web-page structure and content (310). This analysis result, combined with the instruction sets, determines the ad presentation operation (311) in accordance with triggering events.

The whole process of the campaign operation is initialized by a single HTML tag commands which activates the initial java script program. There is no further need for any other HTML objects within the web-page, all advertising campaign operation is controlled by the java script programs and campaign rules. The embedded HTML tag need not to be replaced at any time during the campaign or between campaigns, what is changed is only the java scripts and campaign rules.

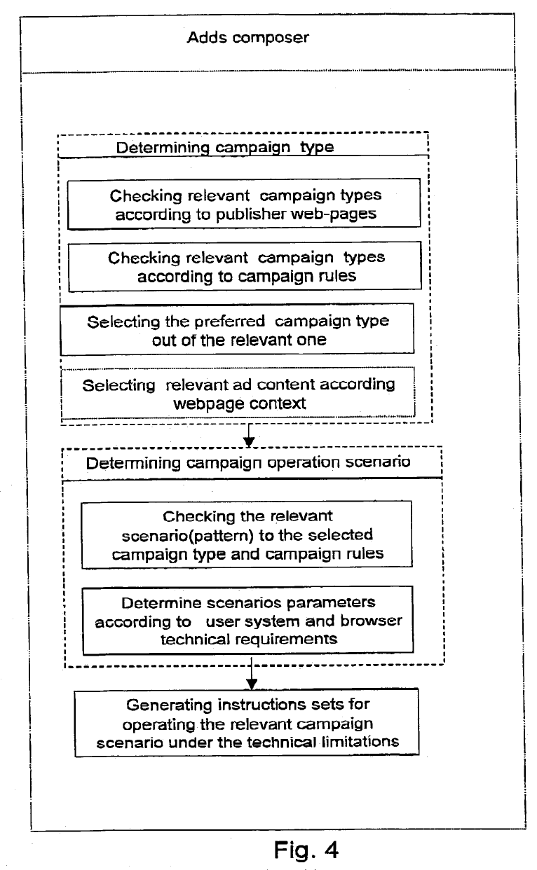

FIG. 4 illustrates a flow chart of the ad composing process. [This composition operation is processed by a designated java script (the initial java script)]. At the first stage the campaign type is determined: the campaign type is selected according to the pre-defined campaign rules and the publisher web-site content and format. At the next stage the operation scenario of the respective campaign type definitions and parameters are selected according to user system and browser application based on the campaign rules. For example, the campaign rule, may define the proper range resolution of an ad image and the ad composer selects the best possible image resolution within the defined range according technical limitation of user device screen.

At the last stage, all selections and preferences of campaign operation are translated into respective instructions sets. The main java script uses these instruction sets in order to activate the campaign presentation accordingly.

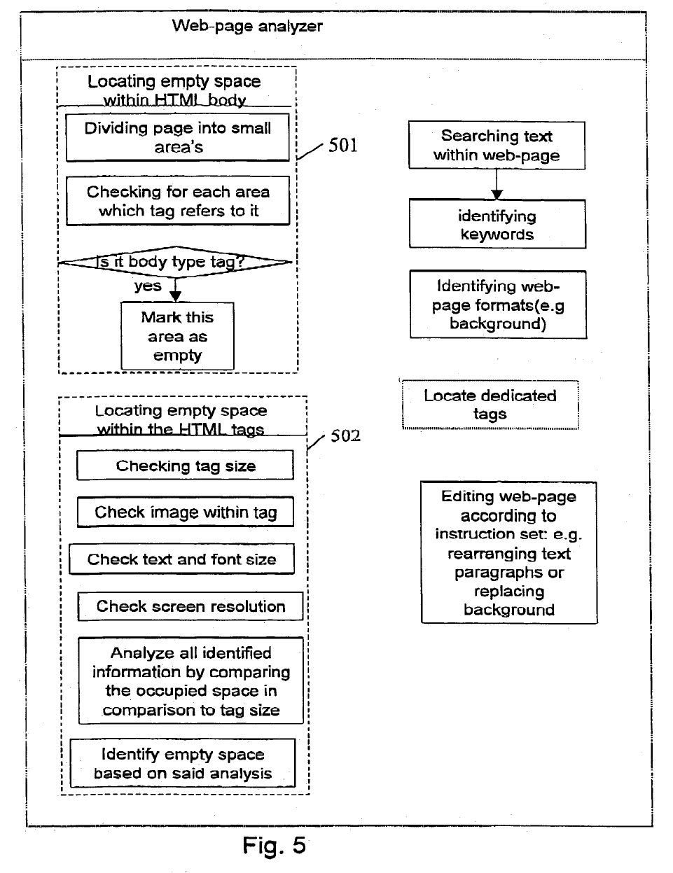

FIG. 5 illustrates the web-page analysis process. One function of the analysis process is to locate empty spaces in the web-page for placing the campaign ads. There are two basic approaches for identifying empty spaces. The first approach (501) is to explore the page structure “inch by inch” and check the relevant tag definition for each page area. Areas containing “body” tags type are marked as empty. The second approach (502) is to search for empty spaces within the HTML tags, which define the page structure. The concept is to check the tag text and image components and estimate the area that they occupy according to font definitions and user device screen resolution. The estimated area is compared to the defined tag size for identifying empty spaces.

The webpage analysis further relates to page format and content. Identifying the keywords within the page text can be used to relate these keywords to ads (for example highlighting a keyword which is associated with the relevant ad) or even selecting the relevant ads accordingly. The identification of page formats properties such as “framing” “scrolling” or background can be used for adapting the ads accordingly. For example the ads colors may be changed according to page background.

In some cases the analysis procedure can be followed by editing the web-page structures. For example changing its background or editing long text paragraph structure for enabling to place ads at more attractive locations.

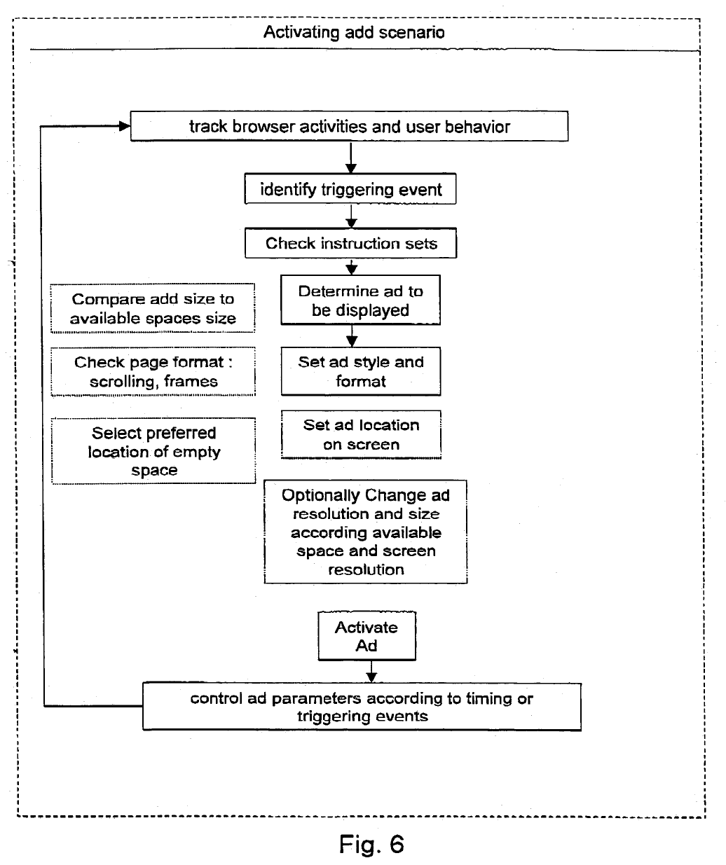

FIG. 6 illustrates the real time process operating the campaign ads. This process, which is handled by the main java scripts, tracks all browsing activities including user behavior such as mouse movements or selections. The program identifies triggering events such timing schedules, scrolling operation or mouse movement for activating new ads or dynamically operating the ads (e.g. animation motion). All of these operations are preformed according to relevant instruction sets, which define the triggering events and the associated action. The instructions sets and rules relate to multiple ad characteristics and triggering events, hence the ad activation and presentation is influenced by combinations of different triggering events and rules and the activation of one ad may influence the activation of another.

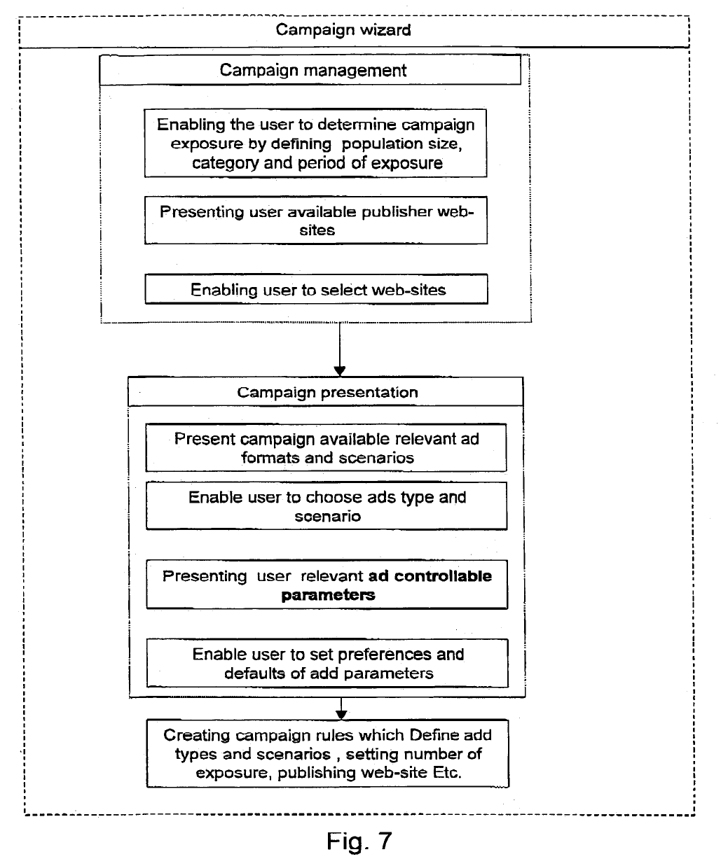

FIG. 7 illustrates the campaign wizard operations. The first function of the campaign wizard is enable the campaign manger to plan the campaign by determining its exposure definitions of population size, category, etc. The manger is presented with the relevant publishing web-sites and selects the relevant one according to his campaign management policy. These campaign management tools are well known in the art and need not to be detailed. According to the present invention it is suggested to provide the user with design tools that enable the campaign manager to determine guiding instructions, which will affect the real time presentations of the campaign ads. The manger is able to select the preferred ad type and scenario and determine his preferences regarding all controllable parameters of the ads such as resolution, appearance timing, location, etc. The parameter's activation can be defined with association to triggering events. (e.g. changing ad size or resolution according to user behavior).

Types of campaign advertisements vary from an advertisement moving across the screen to a traditional fixed advertisement, which may appear in the unused portion of the web page. Advertisements in the present invention may gradually come into focus on one side or may even be an animated advertisement, which moves in place or across the page. If the advertisement is cannot be displayed on the particular page, the system will choose the next best advertisement format for that particular user.

The parameters of the instructions for controlling the ad presentation can include all physical properties, attributes and display techniques of an object, including and not limited to size, shape, geographic screen location (upper, lower, upper-left, lower-right, right, left), movement speed and direction, and appearance styles (fade, flash, zoom). It can also include timed events, from page load or time lapse of ad load as defined during or a time interval thereafter page load. The web page administrator can assume full command over global campaign parameters by definition of an advertisement/content policy, which applies boundaries to geographic screen locations, and advertisement/content types on their web pages (e.g. permit ads in empty spaces only, permit movement over content, define a transparency level for ads when permitted to move over/overlay content). The advertisement administrator must then adhere and will be restricted to instructing adaptive information within the permissible parameters as defined by the web page administrator.

All of the manger's selections and preferences are translated into campaign rules and commands. These command rules are used for the real time composition of the ads according to analysis of the user system and browsing limitations as described above.

According to alternative option the campaign wizard application may include a ready-to-use pre-packaged library of campaign configurations, which will require only the attachment of any standard image file and can be instantaneously launched for those who opt not to construct their own step-by-step campaign. The complexity of instructive and adaptive qualities of timely campaign appearance and behavioral characteristics are virtually unlimited.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A web-page advertisements playing system enabling real time control of web-page advertisement presentation according to pre-determined instruction rules technical browsing parameters, real time events, web-page structure and content, said system comprised of:
a. Instructions rules database wherein the rules can be added or changed by an ad designer;
b. First java script program which analyzes technical browsing limitations and related web-page structure for creating ad playing instruction sets based on predefined rules and said analysis result;
c. Second java script for playing at less one ad wherein the ads appearance timing and characteristics are changed according to created instructions sets and the occurrence of identified triggering events

2. The system according to claim 1 wherein the instruction rule and instructions sets relate to combination of multiple ads characteristics and triggering events, wherein the activation of each ad is influence by combinations of different characteristics and events.

3. The system according to claim 1 wherein instruction rules and instructions sets relate to combination of multiple advertising campaigns appearing in one or more web-pages, wherein the activation of one advertising campaign may influence other advertising campaigns.

4. The system according to claim 1 wherein ad controllable characteristics include size parameters, location parameters (e.g. screen position, scrolling etc.), animation behavior parameters (e.g. motion, speed etc.), appearance period and timing conditional logic, style format parameters (e.g. color, fonts).

5. The system according to claim 1 wherein the technical browsing parameters include: browser type and version operating system type, communication bandwidth speed, width and height of browsing window, IP address etc.

6. The system according to claim 1 wherein the triggering event include scheduled events, browsing events (e.g. downloading), and browsing interaction with user (e.g. mouse movement, scrolling set).

7. The system according to claim 1 wherein the instructions set, include logic parameters representing ad characteristics in relation to triggering events:

8. The system according to claim 1 wherein the instructions rules include logic commands of ad type and preferred characteristics of ads in relation to parameter of browsing technical limitation and web-page structure.

9. The system of claim 1 further comprising ad campaign wizard for enabling campaign designer to create instructions rules by selecting relevant ads type and scenarios, and select the preferred characteristics of the ad presentation;

10. The system of claim 1 wherein the relevant web-page includes only a single permanent HTML tag command for calling the first java script program wherein this java script program activates at least one advertising campaign.

11. The system of claim 1 wherein the first java script program further analyzes page content;

12. The system of claim 1 wherein the first java script program further analyzes web-page structure to locate empty spaces;

13. The system of claim 1 wherein the second java script program further analyzes page content and play relevant ads according to page content and instruction sets;

14. The system of claim 1 wherein the second java script program further edit the web-page text structure for placing ads at new available space;

15. The system of claim 1 wherein the ads are displayed within web-page content, above the web-page content or underneath web-page content;

16. A method for playing web-page advertisements, wherein the advertisements presentation is controlled according to browsing limitations, real time events, web-page structure and content and predetermined campaign rules, said method comprising the steps of;
a. Calling remote java script program;
b. analyzing of browsing technical limitation, relevant web-page characteristics.
c. Creating instruction sets based on analysis result and pre-determined campaign rules; and;
d. playing ads and controlling their characteristics according to identified triggering events and created instructions sets.

17. The method according to claim 16 wherein the instruction rules and instructions sets relate to combination of multiple ads characteristics and triggering events, wherein the activation of each ad is influence by combinations of different characteristics and events.

18. The method according to claim 16 wherein instruction rules and instructions sets relate to combination of multiple advertising campaigns appearing in one or more web-pages, wherein the activation of one advertising campaign may influence other advertising campaigns.

19. The method according to claim 16 wherein ad controllable characteristics include size parameters, location parameters(e.g. screen position, scrolling etc.), animation behavior parameters (e.g. motion, speed etc.), appearance period and timing conditional logic, style format parameters (e.g. color, fonts).

20. The method according to claim 16 wherein the technical browsing application include: browser type and version, operating system type, communication bandwidth speed, width and height of browsing window IP address.

21. The method according to claim 16 wherein the triggering event include scheduled events, browsing events (e.g. downloading, and browsing interaction with user (e.g. mouse movement scrolling etc.),

22. The method according to claim 16 wherein the instructions sets include logic parameters representing ad characteristics in relation to triggering events;

23. The method according to claim 16 wherein the instructions rules include logic commands of ad type and preferred characteristics of ads in relation to parameters of browsing technical limitation and web-page structure/content.

24. The method of claim 16 further comprising the step of enabling campaign designer to automatically create instructions rules by selecting relevant ads type and scenarios, and select the preferred characteristics of the ad presentation;

25. The method of claim 16 wherein the relevant web-page includes only a single permanent HTML tag command for calling the first java script program wherein this java script program activates at least one advertising campaign.

26. The method of claim 14 further comprising the step of analyzing page content and selecting relevant ads accordingly;

27. The method of claim 14 further comprising the steps of locating empty spaces within webpage and placing ads in available spaces;

28. The method of claim 14 further comprising the steps of editing the web-page text structure and placing ads at created available space;

29. The method of claim 14 wherein the ads are displayed within web-page content, above the web-page content or underneath web-page content;

30. An advertising campaign management system implemented within a communication network enabling real time control or web-page advertisement presentations, which are viewed on a computerized device screen, wherein the process of controlling the advertisements presentation is performed by a pre-generated java script program according to instruction rules, which are activated upon the occurrence of identified triggering events, wherein the instruction rules are determined by pre-determined campaign rules, which are applied according to the real time analysis of computerized device's technical limitations, relevant web-page characteristics and web-page content.
